(19) United States
(12) Patent Application Publication
(10) Pub. No.: US 2007/0289423 A1
(43) Pub. Date: Dec. 20, 2007

(54) Method of cutting off steel strip having welded rigid beads

(76) Inventor: Walley Chao, Taichung (TW)

Correspondence Address: BROWDY AND NEIMARK, P.L.L.C.;624 NINTH STREET, NW, SUITE 300, WASHINGTON, DC, 20001-5303, US

(21) Appl. No.: 11/603,009

(22) Filed: Nov. 22, 2006

(30) Foreign Application Priority Data
Jun. 15, 2006 (TW) 95121497

(51) Int. Cl. B26D 1/06

(52) U.S. Cl. 83/13; 83/694

(57) ABSTRACT

A steel strip cutting method includes the steps of: (a) preparing an upper die having a straight accommodation groove and a straight cutting groove and a bottom die having a straight accommodation groove and a straight cutting groove corresponding to the straight accommodation groove and straight cutting groove of the upper die, (b) attaching a steel strip having rigid beads welded to one lateral side thereof to have the rigid beads be accommodated in the straight accommodation groove of the bottom die outside the straight cutting groove, and (c) closing the upper die on the bottom die to cut off the steel strip corresponding to the straight cutting grooves of the upper die and the bottom die.

### BACKGROUND OF THE INVENTION

1. Field of the Invention

The present invention relates to a steel strip cutting method and more particularly, to a steel strip cutting method practical for cutting off a steel strip that has rigid beads welded to one lateral side thereof.

2. Description of the Related Art

Conventional steel strip for use in saw blade is made of carbon steel, which is homogenous material and has the uniform hardness. When cutting off the steel strip, the hardness of the cutting edge of the cutting tool must be higher than that of the steel strip. Besides, the cutting edge of the cutting tool usually has a length greater than the width of the steel strip so that the cutting tool can cut off the steel strip completely and without damage.

However, a composite steel strip is more popular used in producing the bi-metal saw blade. When using a typical cutting tool to cut the composite steel strip which has rigid beads, such as diamond beads, welded to a tooth portion at one lateral side thereof, the cutting edge of the cutting tool may impact the rigid beads, thereby causing damage to the cutting edge thereof.

### SUMMARY OF THE INVENTION

The present invention has been accomplished under the circumstances in view. It is therefore one object of the present invention to provide a steel strip cutting method for cutting off a steel strip having rigid beads welded to one lateral side thereof that cuts off the steel strip without crushing the rigid beads, preventing damage to the mold.

To achieve this and other objects of the present invention, the steel strip cutting method comprises the steps of: (a) preparing an upper die and bottom die, the upper die having a straight accommodation groove and a straight cutting groove extending across the straight accommodation groove, the bottom die having a straight accommodation groove and a straight cutting groove corresponding to the straight accommodation groove and straight cutting groove of the upper die; (b) preparing a steel strip, which has a plurality of rigid beads welded to one lateral side thereof, and then attaching the steel strip to the bottom die to have the rigid beads be accommodated in the straight accommodation groove of the bottom die outside the straight cutting groove of the bottom die and one rigid bead be abutted against one side of the straight cutting groove of the bottom die; and (c) closing the upper die on the bottom die and simultaneously imparting a pressure to the upper die against the bottom die to cut off the steel strip corresponding to the straight cutting grooves of the upper die and the bottom die.

### BRIEF DESCRIPTION OF THE DRAWINGS

FIG. 1 is an exploded view of a mold for cutting off a steel strip in accordance with a first embodiment of the present invention.

FIG. 2 is a schematic drawing showing the steel strip attached to the bottom die of the mold in accordance with the first embodiment of the present invention.

FIG. 3 is a schematic drawing showing the rigid beads of the steel strip accommodated in the straight accommodation grooves of the mold in accordance with the first embodiment of the present invention.

FIG. 4 corresponds to FIG. 3 but showing the two jaws of the mold moved relative to each other against the steel strip.

FIG. 5 is a schematic drawing showing the cutting location at the steel strip in accordance with the first embodiment of the present invention.

FIG. 6 is an exploded view of a mold for cutting off a steel strip in accordance with a second embodiment of the present invention.

FIG. 7 is a schematic drawing showing the cutting location at the steel strip in accordance with the second embodiment of the present invention.

### DETAILED DESCRIPTION OF THE INVENTION

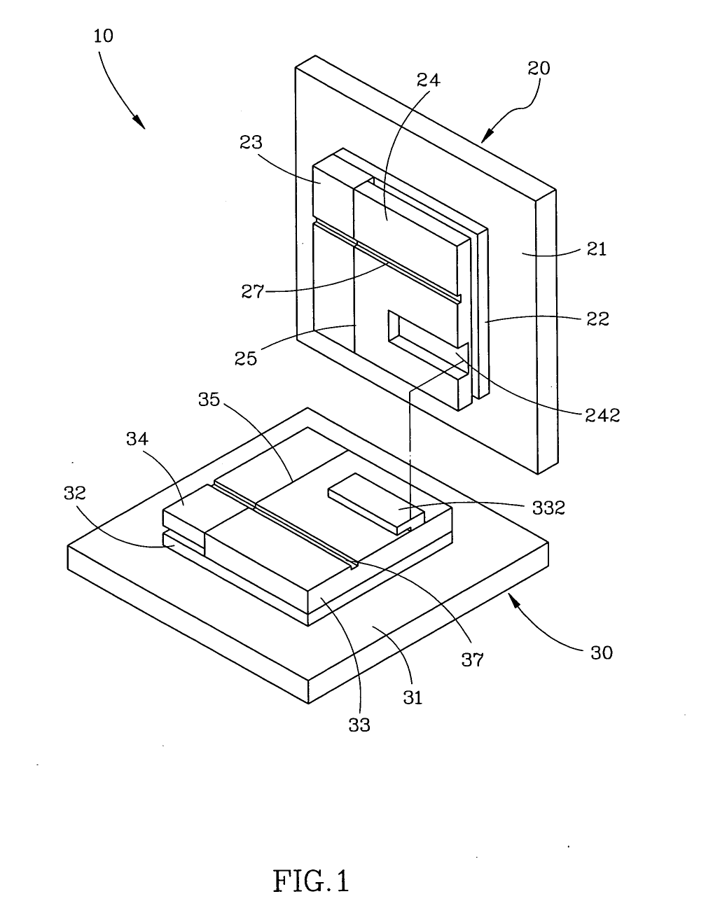

Referring to FIG. 1, a mold 10 for cutting off a steel strip in accordance with a first embodiment of the present invention is shown comprising an upper die 20, and a bottom die 30.

The upper die 20 comprises a flat base 21, a flat bottom plate 22 fixedly provided at the bottom side of the flat base 21, a locating plate 23 fixedly mounted on the bottom side of the flat bottom plate 22, a jaw plate 24 vertically movably suspending from the bottom side of the flat bottom plate 22 at one side of the locating plate 23 and defining with the locating plate 23, a narrow straight cutting groove 25, and a plurality of flexible elastic elements 26 connected between the flat bottom plate 22 and the jaw plate 24 for allowing vertical displacement of the jaw plate 24 relative to the locating plate 23. The flexible elastic elements 26 can be coil springs or polyurethane blocks. According to this embodiment, the flexible elastic elements 26 are polyurethane blocks. Further, a straight accommodation groove 27 is formed on the bottom side of the locating block 23 and the bottom side of the jaw plate 24 and extending across the cutting groove 25. Further, the jaw plate 24 has a coupling groove 242 on the bottom side in parallel to the straight accommodation groove 27.

The bottom die 30 comprises a flat base 31, a flat top plate 32 fixedly provided at the top side of the flat base 31, a locating plate 33 fixedly mounted on the top side of the flat top plate 32 corresponding to the jaw plate 24 of the upper die 20, a jaw plate 34 vertically movably suspending from the bottom side of the flat top plate 32 at one side of the locating plate 33 corresponding to the locating plate 23 of the upper die 20 and defining with the locating plate 33, a narrow straight cutting groove 35 corresponding to the narrow straight cutting groove 25 of the upper die 20, and a plurality of flexible elastic elements 36 connected between the flat top plate 32 and the jaw plate 34 for allowing vertical displacement of the jaw plate 34 relative to the locating plate 33. The flexible elastic elements 36 can be coil springs or polyurethane blocks. According to this embodiment, the flexible elastic elements 36 are polyurethane blocks. Further, a straight accommodation groove 37 is formed on the top side of the locating block 33 and the top side of the jaw plate 34 and extending across the cutting groove 35. Further, the locating plate 33 has a coupling block 332 on the top side corresponding to the coupling groove 242 of the jaw plate 24 of the upper die 20.

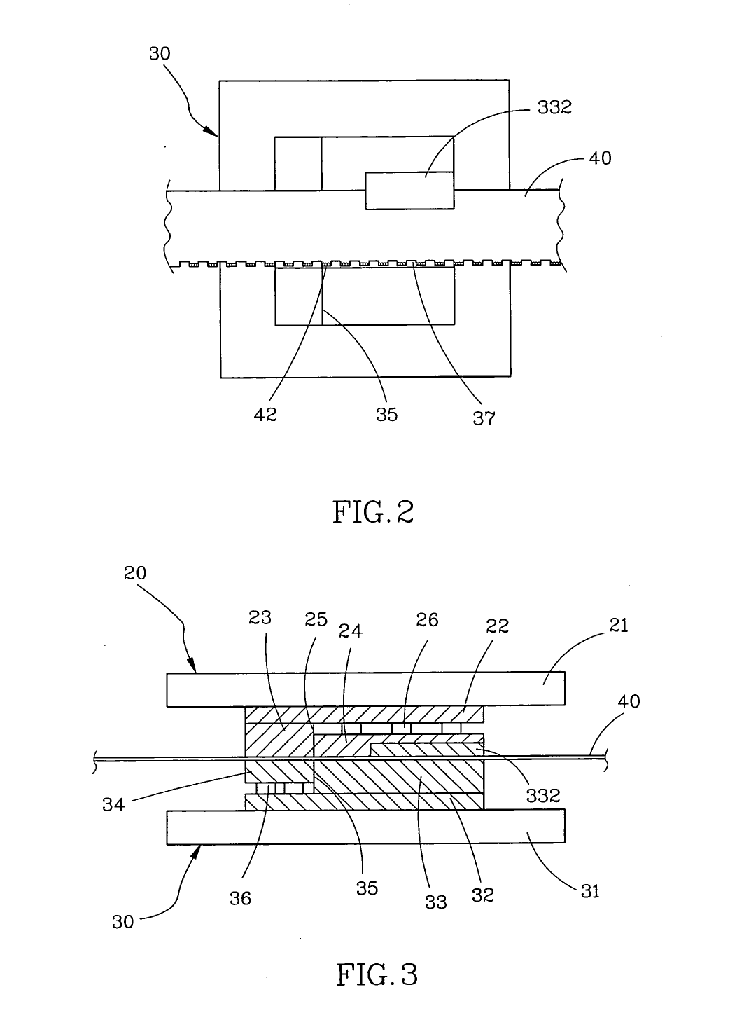

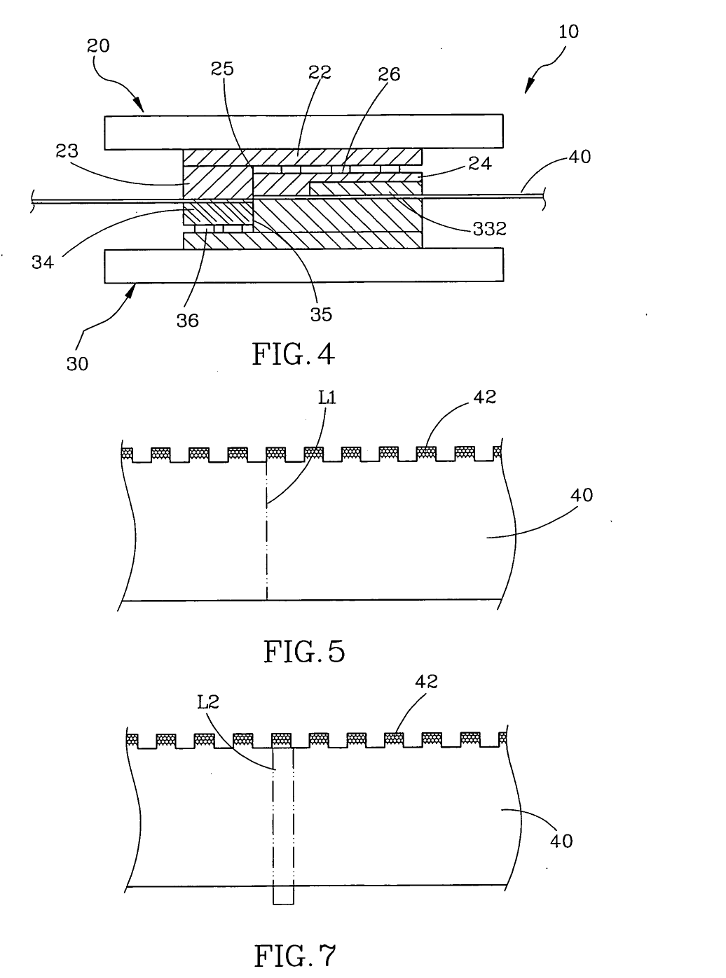

The method of cutting off a steel strip in accordance with the first embodiment of the present invention comprises the steps of:
(a) preparing the aforesaid upper die 20 and bottom die 30;
(b) preparing a steel strip 40 having rigid beads 42 welded to one lateral side thereof, and then attaching the steel strip 40 to the bottom die 30 to have the plain lateral side without rigid beads of the steel strip 40 be stopped at coupling block 332 of the bottom die 30 and the rigid beads 42 be set in the straight accommodation groove 37 and one rigid bead 42 be abutted against one side of the cutting groove 35 as shown in FIG. 2; and
(c) closing the upper die 20 on the bottom die 30 to force the coupling groove 242 into engagement with the coupling block 332 and simultaneously imparting a pressure to the upper die 20 against the bottom die 30 as shown in FIGS. 3 and 4) to cause a scissors action between the jaw plate 24 of the upper die 20 and the jaw plate 34 of the bottom die 30 so that the steel strip 40 is cut off along line L1 (see FIG. 5) corresponding to the cutting groove 25 of the upper die 20 and the cutting groove 35 of the bottom die 30.

As indicated above, the straight accommodation groove 27 of the upper die 20 and the straight accommodation groove 37 of the bottom die 30 accommodate the rigid beads 42 of the steel strip 40 when the steel strip 40 is sandwiched between the upper die 20 and the bottom die 30 for cutting. Therefore, when the jaw plates 24 and 34 are moved relative to each other to cut off the steel strip 40, the rigid beads 42 are not jammed. Therefore, the scissors action of the jaw plates 24 and 34 does not crush the rigid beads 42, and can accurately cut off the steel strip 40 without producing waste chips or causing damage to the mold 10.

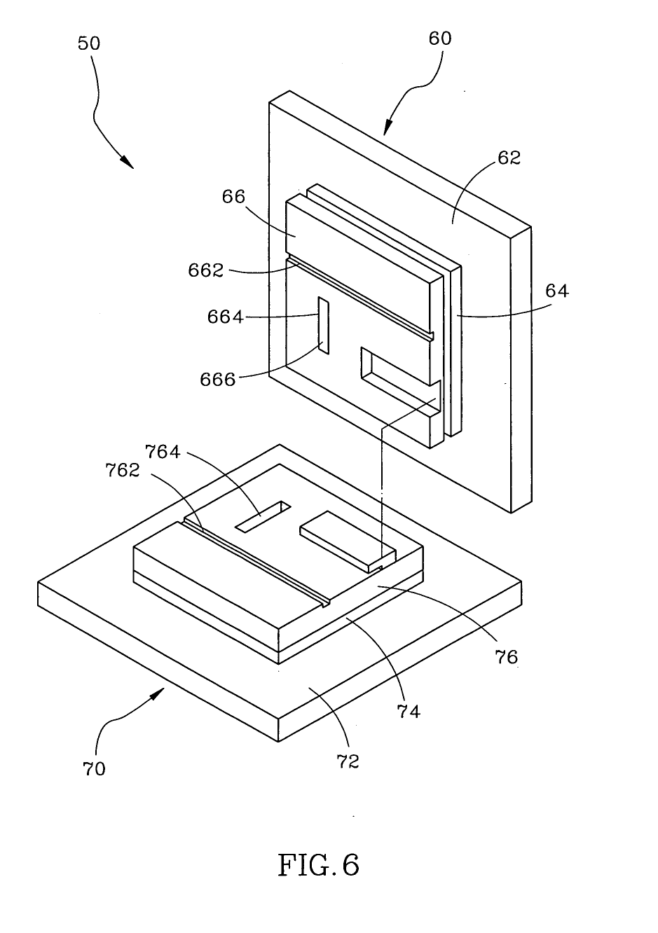

FIG. 6 shows, a mold 50 for cutting off a steel strip in accordance with a second embodiment of the present invention. According to this embodiment, the mold 50 is comprised of an upper die 60, and a bottom die 70. The upper die 60 comprises a flat base 62, a flat bottom plate 64 fixedly provided at the bottom side of the flat base 62, a movable plate 66 vertically movably suspending from the bottom side of the flat bottom plate 64, and a plurality of flexible elastic elements (not shown) connected between the flat bottom plate 64 and the movable plate 66 for allowing vertical displacement of the movable plate 66 relative to the bottom plate 64. The flexible elastic elements can be coil springs or polyurethane blocks. According to this embodiment, the flexible elastic elements are polyurethane blocks. Further, the movable plate 66 has a straight accommodation groove 662, and a punch hole 664. Further, a punch (not shown) is fixedly fastened to the flat bottom plate 64 and suspending in the punch hole 664.

The bottom die 70 comprises a flat base 72, a flat top plate 74 fixedly provided at the top side of the flat base 72, and a locating plate 76 fixedly mounted on the top side of the flat top plate 74 corresponding to the movable plate 66 of the upper die 60. The locating plate 76 has a straight accommodation groove 762 corresponding to the straight groove 662 of the jaw plate 66, and a punch hole 764 corresponding to the punch hole 664 of the upper die 60.

The method of cutting off a steel strip in accordance with the second embodiment of the present invention comprises the steps of:
(a) preparing the aforesaid upper die 60 and bottom die 70;
(b) preparing a steel strip 40 having rigid beads 42 welded to one lateral side thereof, and then attaching the steel strip 40 to the bottom die 70 to have the rigid beads 42 be set in the straight accommodation groove 762; and
(c) closing the upper die 60 on the bottom die 70 and simultaneously imparting a pressure to the upper die 60 against the bottom die 70 so that the movable plate 66 is forced upwards by the locating plate 76 to compress the flexible elastic elements, and the punch is extended out of the punch hole 664 and forced against the steel strip 40 and the locating plate 76 to cut off the steel strip 40 along line L2 (see FIG. 7).

According to the aforesaid second embodiment, waste chips will be produced when cutting off the steel strip 40.

Further, when cutting of the steel strip 40, the mold 50 or 60 does not crush the rigid beads 42 of the belt 40.

Although particular embodiments of the invention have been described in detail for purposes of illustration, various modifications and enhancements may be made without departing from the spirit and scope of the invention. Accordingly, the invention is not to be limited except as by the appended claims

What is claimed is:

1. A steel strip cutting method comprising the steps of:
(a) preparing an upper die and bottom die, said upper die having a straight accommodation groove and a straight cutting groove extending across the straight accommodation groove, said bottom die having a straight accommodation groove and a straight cutting groove corresponding to the straight accommodation groove and straight cutting groove of said upper die;
(b) preparing a steel strip, which has a plurality of rigid beads welded to one lateral side thereof, and then attaching said steel strip to said bottom die to have said rigid beads be accommodated in the straight accommodation groove of said bottom die outside the straight cutting groove of said bottom die and one rigid bead be abutted against one side of the straight cutting groove of said bottom die; and
(c) closing said upper die on said bottom die and simultaneously imparting a pressure to said upper die against said bottom die to cut off said steel strip corresponding to the straight cutting grooves of said upper die and said bottom die.

2. The steel strip cutting method as claimed in claim 1, wherein said upper die comprises a bottom plate, a locating plate fixedly mounted on said bottom plate, a plurality of flexible elastic elements respectively mounted on said bottom plate, and a jaw plate supported on the flexible elastic elements at said bottom plate and defining with the locating plate of said upper die the straight cutting groove of said upper die; the straight accommodation groove of said upper die is formed on the locating plate and jaw plate of said upper die.

3. The steel strip cutting method as claimed in claim 2, wherein said bottom die comprises a top plate, a locating plate fixedly mounted on said top plate corresponding to the jaw plate of said upper die, a jaw plate supported on said top plate corresponding to the locating plate of said upper die and defining with the locating plate of said bottom die the straight cutting groove of said bottom die, and a plurality of flexible elastic elements connected between the top plate and jaw plate of said bottom die; the straight accommodation groove of said bottom die is formed on the locating plate and jaw plate of said bottom die.

4. The steel strip cutting method as claimed in claim 1, wherein the jaw plate of said upper die has a coupling groove; the jaw plate of said bottom die has a coupling block, which is coupled to said coupling groove when said upper die is closed on said bottom die.

5. The steel strip cutting method as claimed in claim 3, wherein said upper die further comprises a flat base plate; the bottom plate of said upper die is fixedly fastened to a bottom side of the flat base plate of said upper die; said bottom die further comprises a flat base plate; the top plate of said bottom die is fixedly fastened to a top side of the flat base plate of said bottom die.

6. The steel strip cutting method as claimed in claim 3, wherein the flexible elastic elements of said upper die and said bottom die are polyurethane blocks.

7. The steel strip cutting method as claimed in claim 3, wherein the flexible elastic elements of said upper die and said bottom die are coil springs.

8. A steel strip cutting method comprising the steps of:
(a) preparing an upper die and a bottom die, said upper die having a straight accommodation groove and a punch hole, said bottom die having a straight accommodation groove and punch hole corresponding to the straight accommodation groove and punch hole of said upper die;
(b) preparing a steel strip, which has a plurality of rigid beads welded to one lateral side thereof, and then attaching said steel strip to said bottom die to have said rigid beads be accommodated in the straight accommodation groove of said bottom die outside the straight cutting groove of said bottom die; and
(c) closing said upper die on said bottom die and simultaneously imparting a pressure to said upper die against said bottom die to cut off said steel strip at a location corresponding to the punch hole of said upper die and the punch hole of said bottom die.

9. The steel strip cutting method as claimed in claim 8, wherein said upper die comprises a flat bottom plate, said flat bottom plate having a bottom side, a movable plate vertically movably suspending from the bottom side of said flat bottom plate, a punch fixedly fastened to and perpendicularly extended from the bottom side of said flat bottom plate and suspending in the punch hole of said upper die, and a plurality of flexible elastic elements connected between said flat bottom plate and said movable plate; the straight accommodation groove of said upper die is formed on a bottom side of said movable plate; the punch hole of said upper die is formed on said movable plate.

10. The steel strip cutting method as claimed in claim 9, wherein the flexible elastic elements of said upper die are polyurethane blocks.

11. The steel strip cutting method as claimed in claim 9, wherein the flexible elastic elements of said upper die are coil springs.

12. The steel strip cutting method as claimed in claim 9, wherein said bottom die comprises a flat top plate, said flat top plate having a top side, and a locating plate fixedly mounted on the top side of said flat top plate corresponding to the movable plate of said upper die; the straight accommodation groove of said bottom die is formed on the top side of said locating plate; the punch hole of said bottom die is formed on said locating plate.

13. The steel strip cutting method as claimed in claim 12, wherein said movable plate of said upper die has a coupling groove; said locating plate of said bottom die has a coupling block, which is coupled to the coupling groove of said movable plate when said upper die is closed on said bottom die.

14. The steel strip cutting method as claimed in claim 12, wherein said upper die further comprises a flat base plate; the bottom plate of said upper die is fixedly fastened to a bottom side of the flat base plate of said upper die; said bottom die further comprises a flat base plate; the top plate of said bottom die is fixedly fastened to a top side of the flat base plate of said bottom die.
